(19) United States
(12) Patent Application Publication
(10) Pub. No.: US 2008/0226873 A1
(43) Pub. Date: Sep. 18, 2008

(54) Material with a shock absorbing capability and related manufacturing methods

(76) Inventor: Jung-Ho Ko, Rende Towship (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,654

(22) Filed: Mar. 14, 2007

(51) Int. Cl. D06N 7/00; B05D 3/00

(52) U.S. Cl. 428/147; 427/194

(57) ABSTRACT

A material having a shock absorbing capability and related method is disclosed. The method of forming the material having a shock absorbing capability is performed by sequentially coating the adhesive agent and utilizing a heating roller to the first substrate layer made of cloth, the second substrate layer made of SBR (styrene butadiene rubber), and the third substrate layer made of natural or artificial leather all together. Because the second substrate layer of the material having a shock absorbing capability is made of SBR (styrene butadiene rubber), which has good shock absorbing and impact buffering effects, the embodiment materials shock absorbing may be utilized in various protective products.

### BACKGROUND OF THE INVENTION

1. Field of the Invention

The present invention is related to a material having a shock absorbing capability and a related manufacturing method, and more particularly, to a material that has a first substrate layer made of cloth, a second substrate layer made of SBR (styrene butadiene rubber), and a third substrate layer made of natural or artificial leather and which may be utilized in various protective products.

2. Description of the Related Art

Typical leather products have a pleasing texture and permit ventilation, i.e., they breath; as a result, such products are very popular and common.

Leather products may be categorized into natural leather products and artificial leather products. Natural leather products are made of animal skin, which have a pleasing texture; however, natural leather requires complicated fabrication processes and is not easy to obtain, and so its cost is usually relatively expensive. Recently, with technological improvements, the manufacturing technologies for artificial leather products are well developed, and yield a product that is very similar to the nature leather product. Artificial leather products requires a relatively simple manufacturing process and also breath. As a result, artificial leather products are increasingly popular and common theses days.

However, neither natural leather products nor artificial leather products provide good shock absorbing abilities; they therefore are not suited for use in products that require shock absorbing qualities or impact buffering effects.

In U.S. patent publication no. 2003/0162454 A1, a leather material is disclosed. The leather material has an upper layer, a middle layer and a lower layer. The lower layer has extensibility, the middle layer has an increased thickness, and so when the leather material is bent, its upper layer does not develop deep wrinkles but only thin lines. This leather material does not provide any shock absorbing or impact buffer effects. Moreover, the three layers of the leather material are bound with glue and then pressed by a roller without a heating or drying process. As a result, the bonding between the three layers may come loose under deformation.

In PCT/KR02/01428, a method of forming a pattern on a leather material is disclosed, but the method does not cause the leather material to have any shock absorbing or impact buffering effects.

Therefore, it is desirable to provide a material having a shock absorbing capability, and related manufacturing methods, to mitigate and/or obviate the aforementioned problems.

### SUMMARY OF THE INVENTION

An objective of the present invention is to provide a material that has a first substrate layer made of cloth, a second substrate layer made of SBR (styrene butadiene rubber), and a third substrate layer made of natural or artificial leather and which may be utilized in various protective products.

The material having a shock absorbing capability of the present invention has the second substrate layer made of SBR (styrene butadiene rubber) with shock absorbing capabilities, the first substrate layer made of cloth disposed on a first surface of the second substrate layer, and the third substrate layer made of natural or artificial leather disposed on a second surface of the second substrate layer.

The method of forming the material having a shock absorbing capability is performed by sequentially coating the adhesive agent and utilizing a heating roller to the first substrate layer made of cloth, the second substrate layer made of SBR (styrene butadiene rubber), and the third substrate layer made of natural or artificial leather all together.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a material having shock absorbing capabilities according to the present invention.

FIG. 2 illustrates manufacturing of a material having shock absorbing capabilities according to the present invention.

FIG. 3 is a flowchart of manufacturing a material having shock absorbing capabilities according to the present invention.

### DETAILED DESCRIPTION OF THE PREFERRED EMBODIMENT

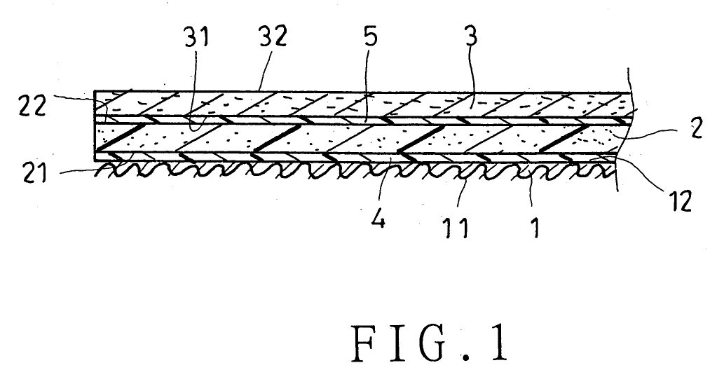

First, please refer to FIG. 1. FIG. 1 shows a material having shock absorbing capabilities according to the present invention. The material having shock absorbing capability is a leather product having three layers, and comprises a first substrate layer 1, a second substrate layer 2, and a third substrate layer 3.

The first substrate layer 1 of the material having shock absorbing capability utilizes a cloth material and has a first surface 11 and a second surface 12. The second substrate layer 2 is disposed on the second surface 12. The second substrate layer 2 also has a first surface 21 and a second surface 22, and the first surface 21 is bonded with the second surface 12 of the first substrate layer 1. An adhesive layer 4 formed from an oil-based glue may be disposed between the first surface 21 of the second substrate layer 2 and the second surface 12 of the first substrate layer 1. The adhesive layer 4 is used to bond together the first substrate layer 1 and the second substrate layer 2. The second substrate layer 2 may be formed from SBR (styrene butadiene rubber), which has shock absorbing capabilities. Then, a third substrate layer 3 may be disposed on the second surface 22 of the second substrate layer 2, and the third substrate layer 3 may be made of natural leather or artificial leather. The natural leather may be made from calf, sheepskin or pigskin. The third substrate layer 3 also has a first surface 31 and a second surface 32, and the first surface 31 is bonded to the second surface 22 of the second substrate layer 2. An adhesive layer 5, which may be composed of an oil-based glue, is disposed between the second surface 22 of the second substrate layer 2 and the first surface 31 of the third substrate layer 3, and is used to bond together the second substrate layer 2 and the third substrate layer 3.

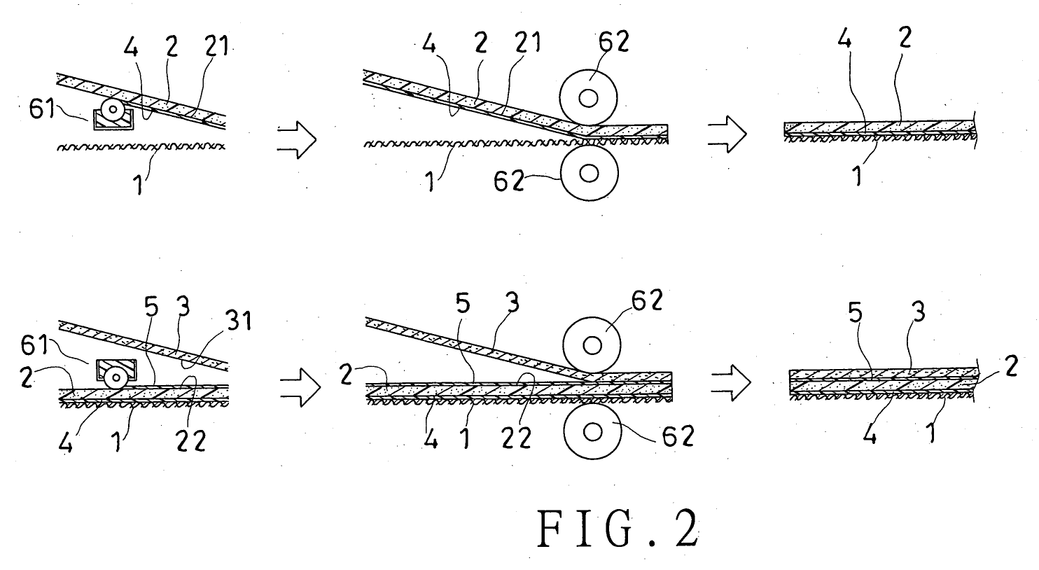

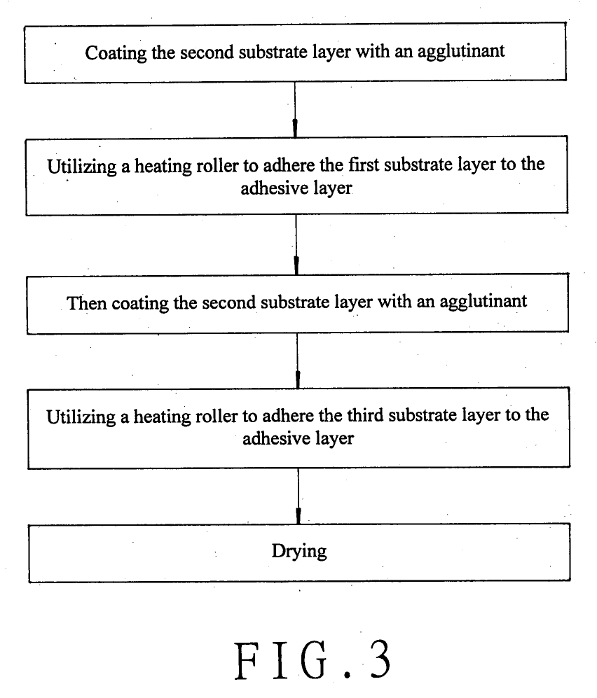

Please refer to FIG. 2 and FIG. 3. FIG. 2 illustrates manufacturing of the material having shock absorbing capability according to the present invention. FIG. 3 is a flowchart of manufacturing the material shock absorbing of the present invention. The manufacturing process for a material having shock absorbing capabilities comprises:

(a) Coating the second substrate layer 2 with an agglutinant; a glue roller 61 may be utilized to coat the agglutinant, which may be made of an oil-based glue, on the first surface 21 of the second substrate layer 2 to form the adhesive layer 4 on the first surface 21.

(b) Utilizing a heating roller to adhere the first substrate layer 1 to the adhesive layer 4; while the adhesive layer 4 on the first surface 21 of the second substrate layer 2 is not fully dry, the second surface 12 of the first substrate layer 1 is oriented to face the first surface 21 of the second substrate layer 2, and a heating roller 62 is used to hot press and bond together the first substrate layer 1 and the second substrate layer 2. The heating temperature may be about 120° C. to 140° C., and the processing time period may be between 7 to 10 seconds.

(c) Once again, coating the second substrate layer 2 with the agglutinant; the glue roller 61 is utilized to coat the agglutinant made from an oil-based glue onto the second surface 22 of the second substrate layer 2 to form the adhesive layer 5 on the second surface 22.

(d) Utilizing a heating roller to bond the third substrate layer 3 to the adhesive layer 5; while the adhesive layer 5 on the second surface 22 of the second substrate layer 2 has not completely dried, the first surface 31 of the third substrate layer 3 is oriented to face the second surface 22 of the second substrate layer 2, and the heating roller 62 is used to hot press and bond together the second substrate layer 2 and the third substrate layer 3. The heating temperature may be about 120° C. to 140° C., and the processing time period may be between 7 to 10 seconds.

(e) Drying; by heating the first substrate layer 1, the second substrate layer 2 and the third substrate layer 3 to remove moisture in the first substrate layer 1, the second substrate layer 2 and the third substrate layer 3, the bond strength between the first substrate layer 1, the second substrate layer 2 and the third substrate layer 3 is increased. Subsequently, the material having shock absorbing capabilities is finished.

The manufacturer may perform additional processes, such as cutting, sewing, etc. the material having shock absorbing capability to form products that have shock absorbing and impact buffering capabilities. Such products may include, for example, baseball gloves, shoe pads, knee guards, etc.

In practice, steps (a) and (b) may be swapped with steps (c) and (d); that is, the second substrate layer 2 and the third substrate layer 3 may be first bonded together, and the second substrate layer 2 and the first substrate layer 1 may subsequently be bonded together.

The oil-based glue may be made from a mixture of PU resin (RA-4066B) and a cross linking agent (RC-75), in a ratio of about 25 kg: 4 kg.

Because the second substrate layer 2 of the material having a shock absorbing capability is made of SBR (styrene butadiene rubber), which has good shock absorbing and impact buffering effects, the embodiment materials shock absorbing may be utilized in various protective products.

Although the present invention has been explained in relation to its preferred embodiment, it is to be understood that many other possible modifications and variations can be made without departing from the spirit and scope of the invention as hereinafter claimed.

What is claimed is:

1. A material with a shock absorbing capability, comprising:
a first substrate layer having a first surface and a second surface; the second surface of the first substrate layer bonded with a first surface of a second surface;
a second substrate layer having a first surface and second surface; the second substrate layer formed from SBR (styrene butadiene rubber) having shock absorbing capability, and the second surface thereof being bonded with a first surface of a third substrate layer;
a third substrate layer having a first surface and a second surface.

2. A material with a shock absorbing capability as claimed in claim 1, wherein the first substrate layer is made of cloth.

3. A material with a shock absorbing capability as claimed in claim 1, wherein the third substrate layer is made of one member chosen from a group of natural and artificial leather.

4. A material with a shock absorbing capability as claimed in claim 3, wherein the natural leather is made of one member chosen from a group of calf, sheepskin and pigskin.

5. A material with a shock absorbing capability as claimed in claim 1, wherein the first surface of said second substrate layer is bonded with the second surface of the first substrate layer by an adhesive layer.

6. A material with a shock absorbing capability as claimed in claim 5, wherein the adhesive layer is formed from an oil-based glue.

7. A material with a shock absorbing capability as claimed in claim 6, wherein the oil-based glue is made from a mixture of PU resin (RA-4066B) and a cross linking agent (RC-75) in a ratio of 25 kg 4 kg.

8. A material with a shock absorbing capability as claimed in claim 1, wherein the first surface of the third substrate layer is bonded with the second surface of the second substrate layer by an adhesive layer.

9. A material with a shock absorbing capability as claimed in claim 8, wherein the adhesive layer is formed from an oil-based glue.

10. A material with a shock absorbing capability as claimed in claim 9, wherein the oil-based glue is made from a mixture of PU resin (RA-4066B) and a cross linking agent (RC-75) in a ratio of 25 kg 4 kg.

11. A method for manufacturing a material having shock absorbing capabilities comprises:
(a) Coating the second substrate layer with an agglutinant; a glue roller may be utilized to coat the agglutinant on the first surface of the second substrate layer formed from SBR (styrene butadiene rubber) and having shock absorbing capability, to form an adhesive layer on the first surface.
(b) Utilizing a heating roller to adhere the first substrate layer to the adhesive layer; while the adhesive layer on the first surface of the second substrate layer is not fully dry, it allows the second surface of the first substrate layer to be bonded with the first surface of the second substrate layer by means of hot press of a heating roller.
(c) Once again, coating the second substrate layer with the agglutinant; the glue roller is utilized to coat the agglutinant onto the second surface of the second substrate layer to form another adhesive layer on the second surface.
(d) Utilizing a heating roller to bond the third substrate layer to the adhesive layer; while the adhesive layer on the second surface of the second substrate layer has not completely dried, it allows the first surface of the third substrate layer to be bonded with the second surface of the second substrate layer by means of hot press of the heating roller.
(e) Drying; the first substrate layer, the second substrate layer and the third substrate layer being bonded together must be heated to remove moisture therein to finish the material having shock absorbing capabilities.

12. A method for manufacturing a material having shock absorbing capabilities as claimed in claim 11, wherein said first substrate layer is made of cloth.

13. A method for manufacturing a material having shock of absorbing capabilities as claimed in claim 11, wherein said third substrate layer is made of one member chosen from a group of natural and artificial leather.

14. A method for manufacturing a material having shock of absorbing capabilities as claimed in claim 13, wherein said natural leather is made of one member chosen from a group of calf, sheepskin and pigskin.

15. A method for manufacturing a material having shock of absorbing capabilities as claimed in claim 11, wherein the heating temperature in said step (b) ranges from 120° C. to 140° C.

16. A method for manufacturing a material having shock of absorbing capabilities as claimed in claim 11, wherein the processing time in the step (b) is between 7 to 10 seconds.

17. A method for manufacturing a material having shock of absorbing capabilities as claimed in claim 11, wherein the heating temperature in said step (d) ranges from 120° C. to 140° C.

18. A method for manufacturing a material having shock of absorbing capabilities as claimed in claim 11, wherein the processing time in the step (d) is between 7 to 10 seconds.

19. A method for manufacturing a material having shock of absorbing capabilities as claimed in claim 11, wherein said adhesive layer is formed from an oil-based glue.

20. A method for manufacturing a material having shock of absorbing capabilities as claimed in claim 11, wherein said oil-based glue is made from a mixture of PU resin (RA-4066B) and a cross linking agent (RC-75) in a ratio of 25 kg:4 kg.
